(19) United States
(12) Patent Application Publication
(10) Pub. No.: US 2018/0097925 A1
(43) Pub. Date: Apr. 5, 2018

(54) MOBILE TERMINAL

(71) Applicant: LG ELECTRONICS INC., Seoul (KR)

(72) Inventors: Grami RYU, Seoul (KR); Yongdeok LEE, Seoul (KR); Yoojin KANG, Seoul (KR); Taeryung RHEE, Seoul (KR); Minjoo KIM, Seoul (KR); Jihye MIN, Seoul (KR)

(73) Assignee: LG ELECTRONICS INC., Seoul (KR)

(21) Appl. No.: 15/678,867

(22) Filed: Aug. 16, 2017

(30) Foreign Application Priority Data
Oct. 5, 2016 (KR) 10-2016-0128575

(51) Int. Cl. H04M 1/725; G04G 99/00; G06F 3/041; G06F 3/01

(52) U.S. Cl. CPC H04M 1/7253; G04G 99/006; G06F 3/017; G06F 3/0412; G06F 3/0416

(57) ABSTRACT

Disclosed herein are a mobile terminal and a method for controlling a mobile terminal. The mobile terminal includes a wireless communication unit configured to be connected to an external device for communication, a sensing unit configured to sense a motion of the mobile terminal, a touch screen, and a controller configured to receive information related to a first item selected in a screen of an application being executed in the external device when a motion of the mobile terminal according to a first gesture of a user who has worn the mobile terminal is sensed, to display a first screen on which the information related to the first item is displayed according to a time sequence on the touch screen, and to transmit a control signal which enables a screen of an application corresponding to a second item selected in the first screen to be displayed to the external device when a motion of the mobile terminal according to a second gesture of the user is sensed. In accordance with the present invention, operations related to an application being executed in an external device can be executed in a watch type mobile terminal while operating in conjunction with the external device.

### CROSS-REFERENCE TO RELATED APPLICATION

Pursuant to 35 U.S.C. § 119(a), this application claims the benefit of earlier filing date and right of priority to Korean Patent Application No. 10-2016-0128575, filed on Oct. 5, 2016, the contents of which are hereby incorporated by reference herein in its entirety.

### BACKGROUND OF THE INVENTION

### Field of the Invention

The present invention relates to a mobile terminal which enables an application to be executed while operating in conjunction with an external device by further taking into consideration user convenience and a method for controlling the same.

### Discussion of the Related Art

With the development of a technology, a mobile terminal is developed in various forms. As part of the forms, a watch type mobile terminal, that is, a wearable device, is used. The watch type mobile terminal may perform the same function as that of a common mobile terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

There is a need to use a watch type mobile terminal while operating in conjunction with a common mobile terminal, and it is necessary to develop a user interface which may be applied to a watch type mobile terminal.

### SUMMARY OF THE INVENTION

Accordingly, an object of the present invention is to address the above-noted and other problems.

Another object of the present invention is to provide a watch type mobile terminal, which enables an operation related to an application being executed in an external device to be executed while operating in conjunction with the external device and a method for controlling the same.

In accordance with an aspect of the present invention, there is provided a watch type mobile terminal, including a wireless communication unit configured to be connected to an external device for communication, a sensing unit configured to sense a motion of the mobile terminal, a touch screen, and a controller configured to receive information related to a first item selected in a screen of an application being executed in the external device when a motion of the mobile terminal according to a first gesture of a user who has worn the mobile terminal is sensed, to display a first screen on which the information related to the first item is displayed according to a time sequence on the touch screen, and to transmit a control signal which enables a screen of an application corresponding to a second item selected in the first screen to be displayed to the external device when a motion of the mobile terminal according to a second gesture of the user is sensed.

The first item may include contact information included in a contact list application. The controller may be configured to display communication histories between the user and a counterpart corresponding to the contact information on the first screen according to a time sequence.

The communication history may include at least one of a call log, a message, and an SNS log between the counterpart and the user. The controller may be configured to transmit a control signal which enables the execution screen of an application corresponding to a selected communication history of the communication histories displayed on the first screen to be displayed when the motion of the mobile terminal according to the second gesture of the user is sensed.

The first item may include date information included in a calendar application. The controller may be configured to display schedule information set in accordance with the date information on the first screen according to a time sequence.

The controller may be configured to transmit a control signal which enables a screen for editing a schedule selected in the first screen to be displayed to the external device when the motion of the mobile terminal according to the second gesture of the user is sensed.

The controller may be configured to display an analog watch screen in the background of the first item and to display the information related to the first item by mapping the information to the analog watch screen so that the information corresponds to a generated time sequence.

The controller may be configured to change the display of the information related to the first item in response to a touch input received in the first screen.

The controller may be configured to change information related to the second item in a screen of an application corresponding to the second item based on a sensed motion when the motion of the mobile terminal according to a third gesture of the user is sensed.

The controller may be configured to receive a touch input in a predetermined direction in the first screen and to change the information related to the first item displayed on the first screen according to a time sequence based on the direction of the received touch input.

The mobile terminal and the method for controlling the same according to embodiments of the present invention may have the following advantages.

In accordance with at least one of the embodiments of the present invention, there is an advantage in that an operation related to an application can be conveniently performed because operations related to an application being executed in an external device are sequentially performed in a watch type mobile terminal in response to a user gesture while operating in conjunction with the external device.

Furthermore, in accordance with at least one of the embodiments of the present invention, there is an advantage in that information about a counterpart can be conveniently checked because information related to a communication history with a counterpart is displayed on an external device and a watch type mobile terminal while operating in conjunction with each other in response to a user gesture.

Furthermore, in accordance with at least one of the embodiments of the present invention, there is an advantage in that schedule information can be conveniently checked because schedule information about a date selected in a calendar application is displayed on an external device and a watch type mobile terminal while operating in conjunction with each other in response to a user gesture.

Furthermore, in accordance with at least one of the embodiments of the present invention, there is an advantage in that displayed information can be checked more intuitively because displayed information is differently displayed on a screen of a watch type mobile terminal in response to a touch input.

Furthermore, in accordance with at least one of the embodiments of the present invention, there is an advantage in that a specific input can be applied in response to a simple gesture of a user by changing information in an external device in response to a user gesture in the state in which the user has worn a watch type mobile terminal.

Furthermore, in accordance with at least one of the embodiments of the present invention, there is an advantage in that the past or future information can be conveniently checked by changing displayed information according to a time sequence based on the direction of a touch input for a watch type mobile terminal.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a block diagram of a mobile terminal in accordance with the present disclosure.

FIG. 2 is a perspective view showing an example of a watch type mobile terminal 300, which is related to another embodiment of the present invention.

FIG. 3 is a flowchart illustrating a method for controlling a mobile terminal according to an embodiment of the present invention.

FIGS. 4 to 14 are diagrams illustrating an example in which operations related to an application are executed in the watch type mobile terminal while operating in conjunction with an external device in accordance with an embodiment of the present invention.

FIG. 15 is a flowchart illustrating a method for executing an operation related to a calendar application in the watch type mobile terminal while operating in conjunction with an external device in accordance with an embodiment of the present invention.

FIGS. 16 to 19 are diagrams illustrating an example in which operations related to the calendar application are executed in the watch type mobile terminal while operating in conjunction with an external device in accordance with an embodiment of the present invention.

FIG. 20 is a flowchart illustrating a method for displaying detailed information related to information displayed on the touch screen in accordance with an embodiment of the present invention.

FIGS. 21 to 23 are diagrams illustrating an example in which detailed information related to information displayed on the touch screen is displayed in response to a touch input in accordance with an embodiment of the present invention.

FIG. 24 is a flowchart illustrating a method for magnifying information displayed on the touch screen and displaying the magnified information in accordance with an embodiment of the present invention.

FIGS. 25 to 27 are diagrams illustrating an example in which information displayed on the touch screen is magnified and displayed and information about another part is checked in accordance with an embodiment of the present invention.

FIG. 28 is a flowchart illustrating a method for changing information about an application in response to a user gesture in accordance with an embodiment of the present invention.

FIGS. 29 to 31 are diagrams illustrating an example in which information about an application is changed in response to a user gesture in accordance with an embodiment of the present invention.

FIGS. 32 to 34 are diagrams illustrating an example in which an image included in an application is displayed on the watch type mobile terminal while operating in conjunction with an external device in accordance with an embodiment of the present invention.

FIGS. 35 and 36 are diagrams illustrating an example in which information displayed on the touch screen is changed based on the direction of a touch input in accordance with an embodiment of the present invention.

FIGS. 37 to 39 are diagrams illustrating an example in which the location of an external device connected to the watch type mobile terminal for communication is displayed in accordance with an embodiment of the present invention.

### DETAILED DESCRIPTION OF THE EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

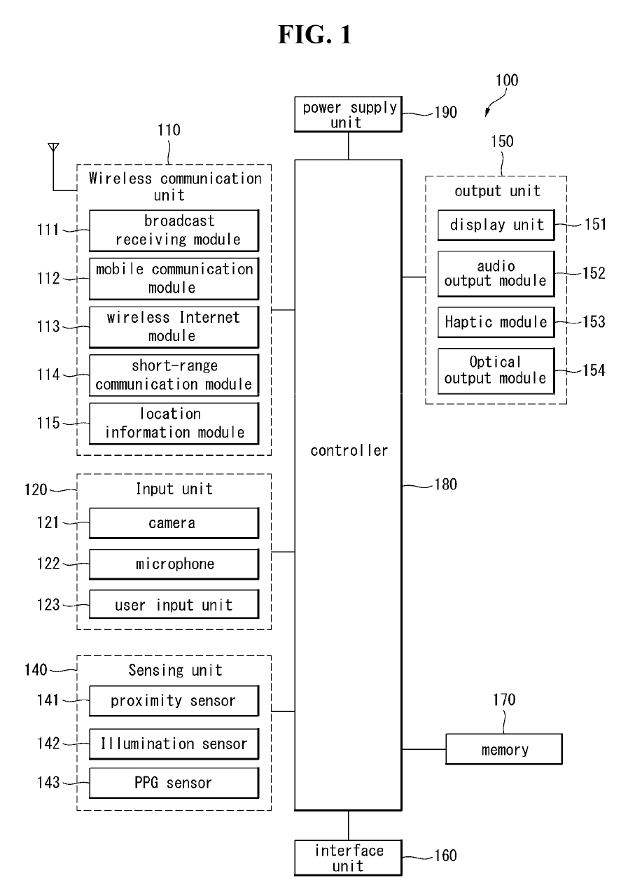

FIG. 1 is a block diagram of a mobile terminal in accordance with the present disclosure.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various types of information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

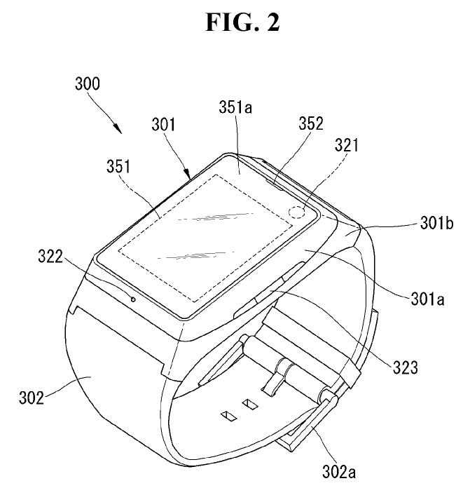

FIG. 2 is a perspective view illustrating one example of a watch-type mobile terminal 300 in accordance with another exemplary embodiment. As illustrated in FIG. 2, the watch-type mobile terminal 300 includes a main body 301 with a display unit 351 and a band 302 connected to the main body 301 to be wearable on a wrist. In general, mobile terminal 300 may be configured to include features that are the same or similar to that of mobile terminal 100 of FIG. 1.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

Further preferred embodiments will be described in more detail with reference to additional drawing figures. It is understood by those skilled in the art that the present features can be embodied in several forms without departing from the characteristics thereof.

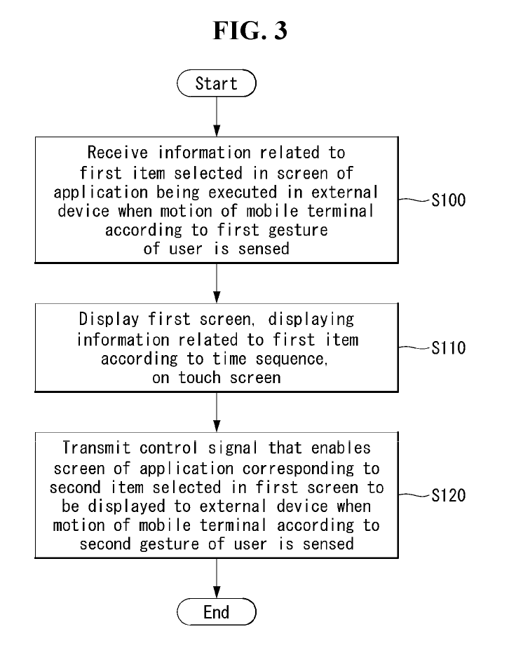

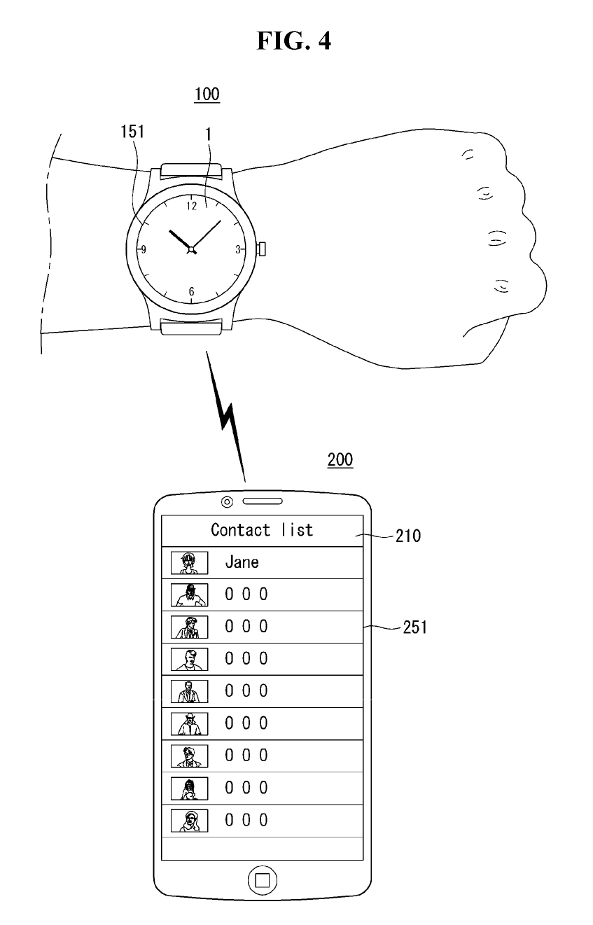

FIG. 3 is a flowchart illustrating a method for controlling a mobile terminal according to an embodiment of the present invention. FIGS. 4 to 14 are diagrams illustrating an example in which operations related to an application are executed in the watch type mobile terminal while operating in conjunction with an external device in accordance with an embodiment of the present invention.

A method for controlling a mobile terminal according to an embodiment of the present invention may be implemented in the mobile terminal 100 described with reference to FIG. 1. A method for controlling a mobile terminal according to an embodiment of the present invention and an operation of the mobile terminal 100 for implementing the method are described in detail below with reference to required drawings.

Referring to FIG. 3, when a motion of the watch type mobile terminal according to a first gesture of a user is sensed, the controller 180 may receive information related to a first item selected in a screen of an application being executed in an external device at step S100.

Referring to FIG. 4, the watch type mobile terminal 100 may be worn on one area of the body, such as the wrist of a user. For example, an analog watch screen 1 indicative of the current time may be displayed on the touch screen 151 of the watch type mobile terminal 100. The term “mobile terminal” to be described hereunder may be understood as indicating a watch type mobile terminal unless described otherwise.

The controller 180 of the mobile terminal 100 may be connected to an external device 200 for communication through the wireless communication unit 110. The external device 200 is another mobile terminal which is used by a user of the mobile terminal 100, and may include a handheld phone, a smart phone, a PDA, a PMP, a tablet PC, a glass type terminal, an HMD and so on.

As shown in FIG. 4, the execution screen 210 of an application may be displayed on the display unit 251 of the external device 200. For example, the application may be a contact list application. Contact information stored in the memory 170 of the mobile terminal 100 may be displayed on the execution screen 210 of the contact list application.

The mobile terminal 100 may be connected to the external device 200 for communication through the wireless communication unit 110. A communication setup method between the mobile terminal 100 and the external device 200 complies with the contents described with reference to FIG. 1, and a detailed description thereof is omitted.

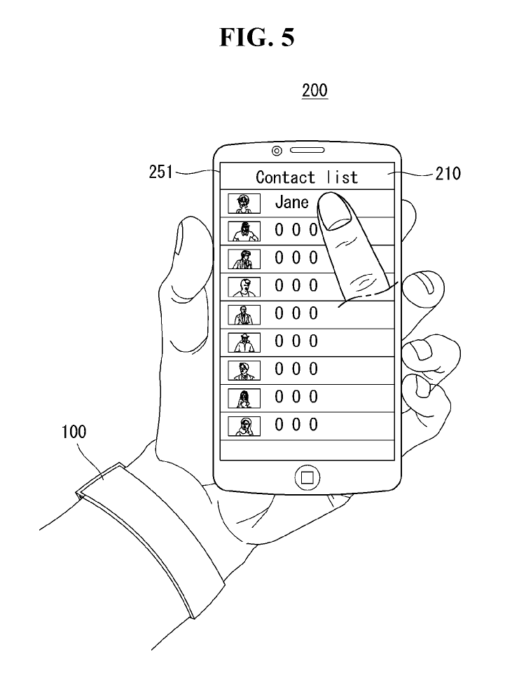

Referring to FIG. 5, a user may check the execution screen 210 of the contact list application displayed on the external device 200 in the state in which the user has worn the mobile terminal 100 on his or her wrist. For example, the user may select a first item, that is, one (e.g., “Jane”) of contact information displayed on the execution screen 210.

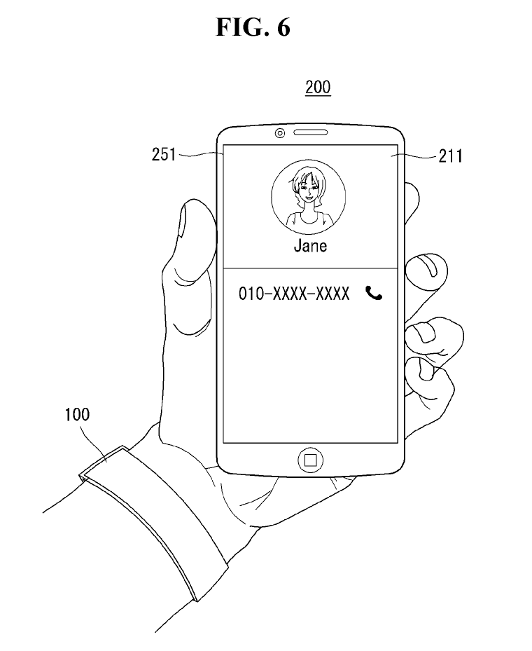

In response to the user selection, the controller of the external device 200 may display a screen 211 including the contact information, that is, the selected first item, on the display unit 251 as shown in FIG. 6. The contact information may include an image or the telephone number of a counterpart corresponding to the contact information.

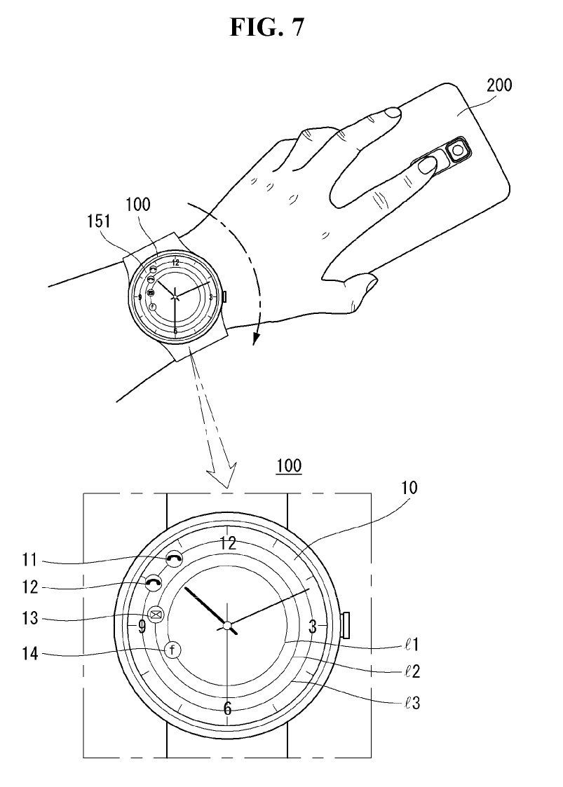

In this state, as shown in FIG. 7, the user may make a first gesture to inward turn the wrist in order to check the mobile terminal 100 worn on the wrist. This is only an example and the present invention is not limited thereto. In some embodiments, another gesture may be set as the first gesture. The sensing unit 140 of the mobile terminal 100 may include various sensors capable of sensing a motion of the mobile terminal 100 according to a gesture of a user, such as an acceleration sensor and a terrestrial magnetism sensor.

In FIG. 7, the user has been illustrated as holding the external device 200 by the hand on which the mobile terminal 100 has been worn and making the first gesture, but the present invention is not limited thereto. For another example, the user may make the first gesture in the state in which the user holds the external device 200 by the other hand or puts the external device 200 on the ground. Even in such a case, the following description may be applied substantially in the same manner.

Sensors included in the sensing unit 140 may include any sensor regardless of its type and method if it can sense a gesture of a user who has worn the watch type mobile terminal 100. A gesture of the user sensed by the sensing unit 140 may include the turn, a movement in a specific direction or the folding of a finger of the wrist on which the mobile terminal 100 has been worn.

When a motion of the mobile terminal 100 according to the first gesture is sensed by the sensing unit 140, the controller 180 may receive the information related to the selected first item through the wireless communication unit 110. For example, when the motion is sensed, the controller 180 may be configured to request the information related to the first item from the external device 200.

For example, the first item may include contact information included in the contact list application. In this case, the information related to the first item may be a communication history between the user and a counterpart corresponding to the contact information. The communication history may include at least one of a call log, a message and an SNS log between the counterpart and the user. This is only an example and the present invention is not limited thereto. The communication history may include any communication history between the counterpart and the user regardless of its type.

Referring back to FIG. 3, the controller 180 may display a first screen, displaying the information related to the first item according to a time sequence, on the touch screen at step S110.

Referring to FIG. 7, the controller 180 may display a first screen 10 on which communication histories 11, 12, 13, and 14, that is, the received information related to the first item, are displayed according to a time sequence on the touch screen 151. The first screen 10 may include the analog watch screen indicative of the current time as a background. In FIG. 7m the four communication histories 11, 12, 13, and 14 have been illustrated, but the present invention is not limited thereto. The number of communication histories displayed on the first screen 10 may be based on the number of communication histories exchanged between the counterpart and the user.

For example, the communication histories 11, 12, 13, and 14 may be displayed at respective times corresponding to the times when the communication histories 11, 12, 13, and 14 were performed on the analog watch screen of the first screen 10. That is, if the communication history 11 was performed between the counterpart and the user at 11:00 on that day, the communication history 11 may be displayed around 11:00.

For example, the communication histories 11, 12, 13, and 14 may be displayed by the forenoon and the afternoon. For example, a communication history performed in the forenoon and a communication history performed in the afternoon may be displayed in different colors. This is only an example and the present invention is not limited thereto. If the forenoon and the afternoon can be classified, any visual effect including a symbol, text, etc. may also be applied to the communication history.

For example, the communication histories 11, 12, 13, and 14 may be displayed as different icons depending on their type, as shown in FIG. 7. For example, the communication histories 11 and 12 may be displayed as an icon indicative of a call log between the counterpart and the user. Furthermore, the communication history 13 may be displayed as an icon indicative of a message between the counterpart and the user. Furthermore, the communication history 14 may be displayed as an icon indicative of the SNS log of the counterpart.

For example, the communication histories 11, 12, 13, and 14 may be displayed as different lines l1, l2, and l3 depending on their type, as shown in FIG. 7. Alternatively, the controller 180 may display the communication histories 11, 12, 13, and 14 as different lines depending on whether they have been performed in the forenoon or the afternoon.

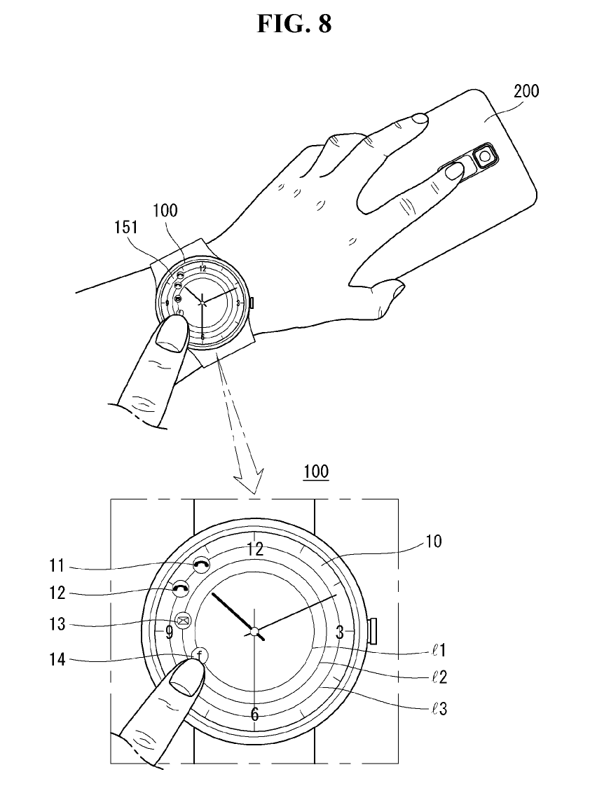

Referring to FIG. 8, the user may select the communication history 14 that belongs to the communication histories 11, 12, 13, and 14 displayed on the first screen 10 and that is to be checked as a second item. For example, when a predetermined touch input (e.g., a force touch input applied with a first strength) is inputted to the communication history 14, the controller 180 may display information about the selected communication history 14 on the touch screen 151.

For another example, when another predetermined touch input (e.g., a force touch input applied with a second strength) is inputted to the communication history 14, the controller 180 may display a mark, indicating that the selected communication history 14 has been selected, in the communication history 14.

Referring back to FIG. 3, when a motion of the mobile terminal according to a second gesture of the user is sensed, the controller 180 may transmit a control signal that enables a screen of an application corresponding to a second item selected in the first screen to be displayed to the external device at step S120.

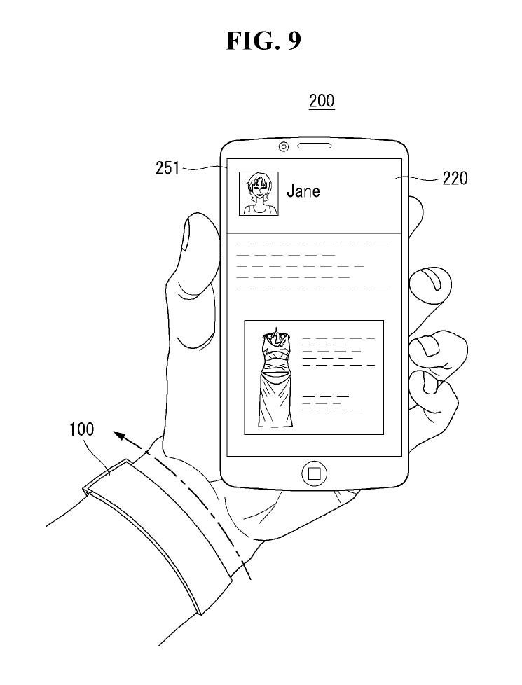

As shown in FIG. 9, the user may make a second gesture to outward turn the wrist on which the mobile terminal 100 has been worn in order to check the external device 200 on his or her hand. This is only an example and the present invention is not limited thereto. In some embodiments, another gesture may be set as the second gesture.

In FIG. 9, the user has been illustrated as holding the external device 200 by the hand on which the mobile terminal 100 has been worn and making the second gesture, but the present invention is not limited thereto. For another example, the user may make the second gesture in the state in which the user holds the external device 200 by the other hand or puts the external device 200 on the ground. Even in such a case, the following description may be applied substantially in the same manner.

When a motion of the mobile terminal 100 according to the second gesture is sensed, the controller 180 may transmit a control signal that enables a screen of an application corresponding to the selected second item to be displayed to the external device 200. For example, if the second item is the communication history 14, the controller 180 may transmit a control signal that enables the execution screen of an SNS application corresponding to the communication history 14 to be displayed to the external device 200.

Referring to FIG. 9, the controller of the external device 200 may execute the SNS application in response to the control signal. The controller of the external device 200 may display the execution screen 220 of the SNS application on the display unit 251. The user may check SNS logs, uploaded by a counterpart, in the execution screen 220.

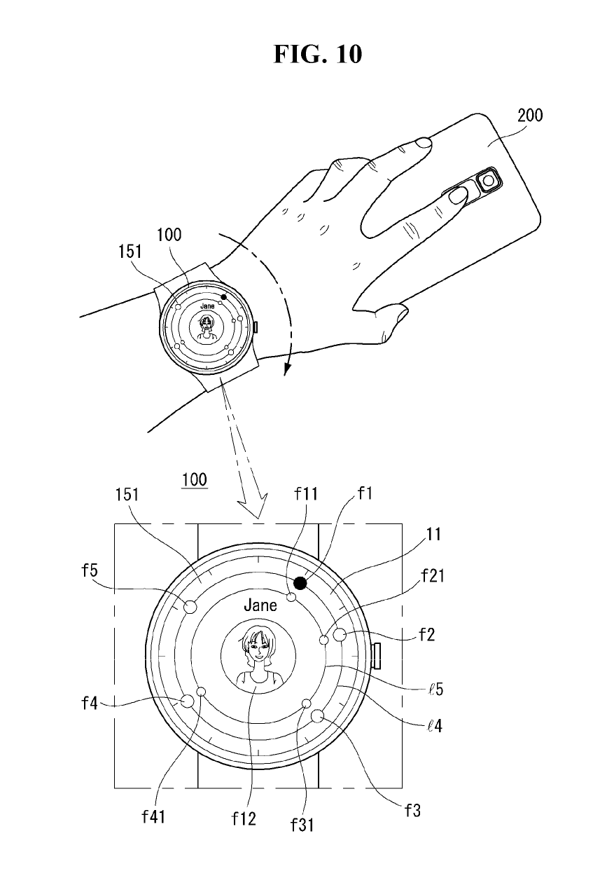

In this state, as shown in FIG. 10, the user may make a gesture to inward turn the wrist, that is, the first gesture again. When a motion of the mobile terminal 100 according to the first gesture is sensed, the controller 180 may display a screen 11 on which the SNS logs uploaded by the counterpart are displayed according to a time sequence on the touch screen 151.

For example, icons f1, f2, f3, f4, and f5 indicative of the uploaded SNS logs, respectively, may be displayed on the screen 11 in the same line l4. Icons f11, f21, f31, and f41 indicative of uploaded responses from other persons with respect to the respective SNS logs f1, f2, f3, f4, and f5 may be displayed in a different line l5 within the line l4. Numbers within the icons f11, f21, f31, and f41 may be indicative of the number of uploaded responses from other persons, such as comments.

When the user selects the icon f1 indicative of an SNS log to be checked, the controller 180 may display a mark indicating that the icon f1 has been selected. The controller 180 may display an image f12, attached to the SNS log indicated by the icon f1, at the center of the screen 11. When the user selects one of the icons f11, f21, f31, and f41 in order to check responses from other persons, the controller 180 may display responses from other persons, corresponding to the selected icon, at the center of the screen 11.

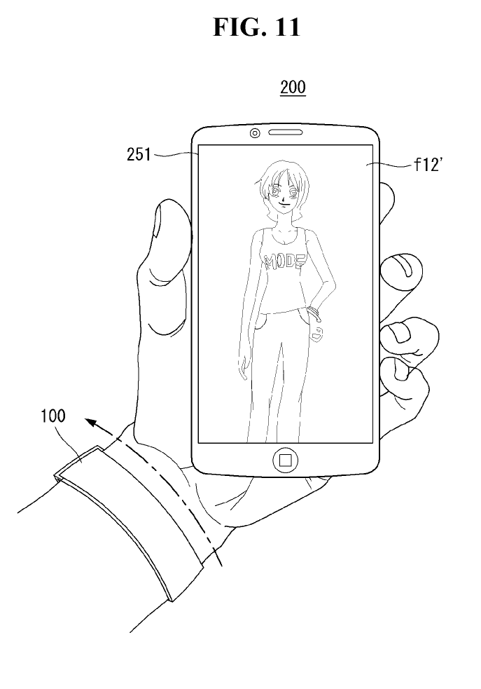

Referring to FIG. 11, the user may make a gesture to outward turn the wrist, that is, the second gesture, again in the state in which the icon f1 has been selected. When a motion of the mobile terminal 100 according to the second gesture is sensed, the controller 180 may transmit a control signal that enables an image f12′ attached to the SNS log indicated by the selected icon f1 to be displayed to the external device 200. The controller of the external device 200 may display the image f12′ on the display unit 251 in response to the control signal.

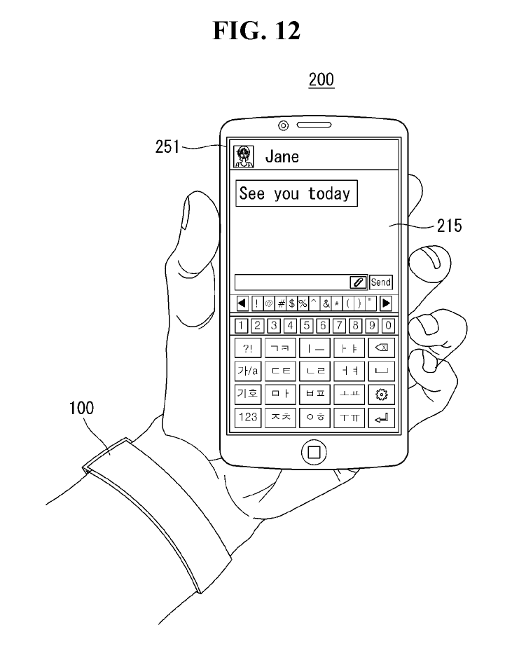

For another example, if the communication history 13 corresponding to a message has been selected as the second item in the first screen 10 of FIG. 7, the controller 180 may transmit a control signal that enables the execution screen of a message application to be displayed to the external device 200. In this case, the controller of the external device 200 may execute the message application. The controller of the external device 200 may display a message window 215 with a counterpart, as shown in FIG. 12.

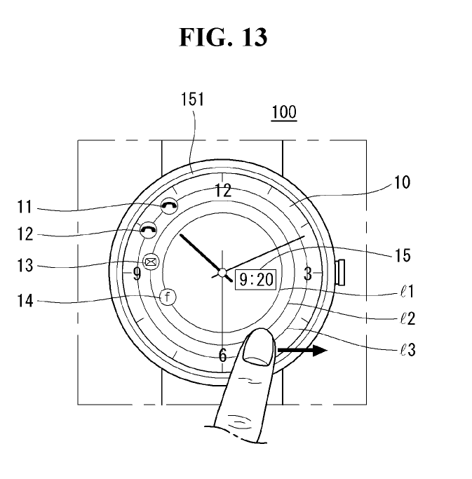

Referring to FIG. 13, as described above with reference to FIG. 7, the communication histories 11, 12, 13, and 14 may be displayed on the first screen 10 at respective times corresponding to the times when the communication histories 11, 12, 13, and 14 were performed. For example, date information 15 when the user performed the communication histories 11, 12, 13, and 14 may be displayed on the first screen 10.

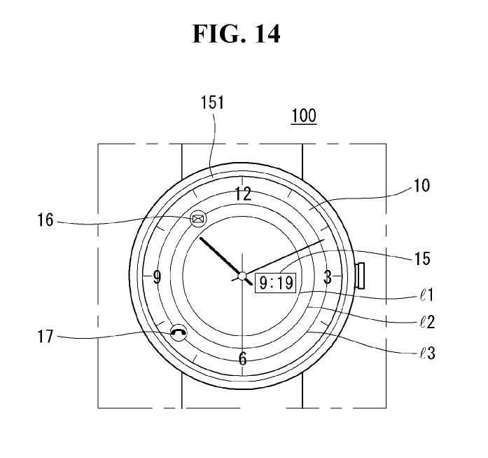

For example, a user may apply a flick touch input to the right in the first screen 10. In response to the flick touch input, the controller 180 may display communication histories 16 and 17, performed the day before, on the first screen 10 as shown in FIG. 14. In this case, the date information 15 displayed on the first screen may be changed from September 20 to September 19.

Likewise, a user may apply a flick touch input to the left in the first screen 10 of FIG. 13. In response to the flick touch input, the controller 180 may display a communication history, performed the next day, on the first screen 10. In this case, the date information 15 displayed on the first screen may be changed from September 20 to September 21.

As described above, the watch type mobile terminal 100 and the external device 200 may sequentially operate while in conjunction in response to a user gesture in relation to the execution of a specific application.

Accordingly, a user can perform operations related to an application conveniently because operations related to an application being executed in an external device are sequentially executed in the watch type mobile terminal while operating in conjunction with the external device in response to a user gesture. Furthermore, a user can check information about a counterpart conveniently because information related to a communication history with the counterpart is displayed through interoperability between an external device and the watch type mobile terminal in response to a user gesture.

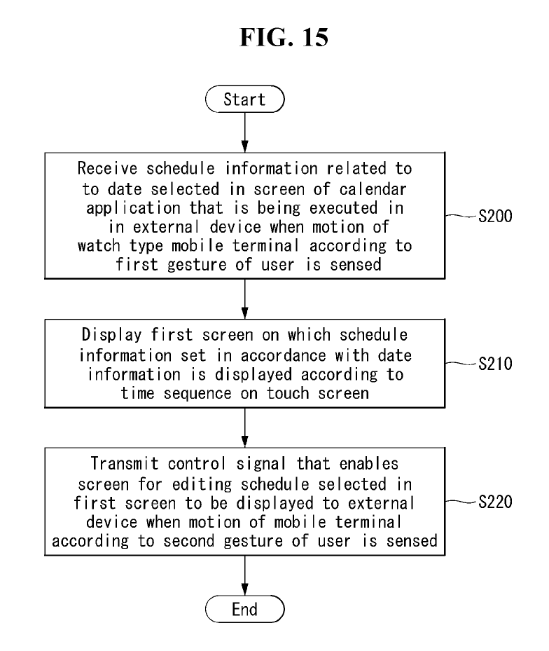

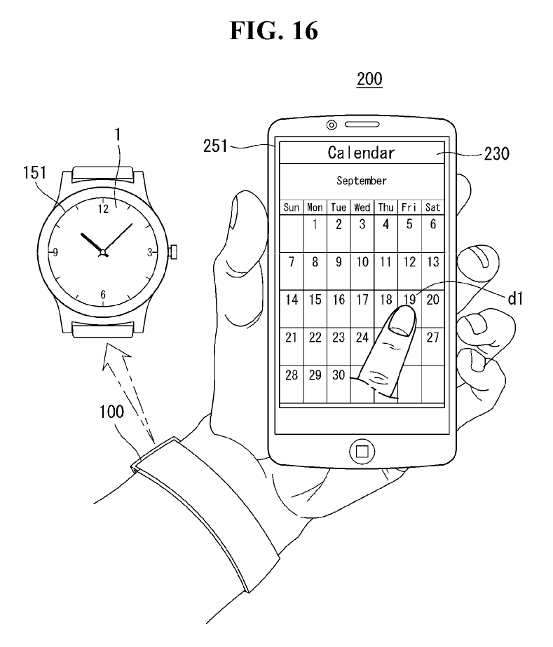

FIG. 15 is a flowchart illustrating a method for executing an operation related to a calendar application in the watch type mobile terminal while operating in conjunction with an external device in accordance with an embodiment of the present invention. FIGS. 16 to 19 are diagrams illustrating an example in which operations related to the calendar application are executed in the watch type mobile terminal while operating in conjunction with an external device in accordance with an embodiment of the present invention.

A method for controlling a mobile terminal according to an embodiment of the present invention may be implemented in the mobile terminal 100 described with reference to FIG. 1. A method for controlling a mobile terminal according to an embodiment of the present invention and an operation of the mobile terminal 100 for implementing the method are described in detail below with reference to required drawings.

Referring to FIG. 15, when a motion of the watch type mobile terminal according to a first gesture of a user is sensed, the controller 180 may receive schedule information related to a date selected in a screen of a calendar application that is being executed in the external device at step S200.

As shown in FIG. 16, the execution screen 230 of a calendar application may be displayed on the display unit 251 of the external device 200. A user may check the execution screen 230 of the calendar application displayed on the external device 200 in the state in which the user has worn the mobile terminal 100 on his or her wrist. For example, the user may select a first item, that is, one (e.g., d1, “September 20”) of date information displayed on the execution screen 230.

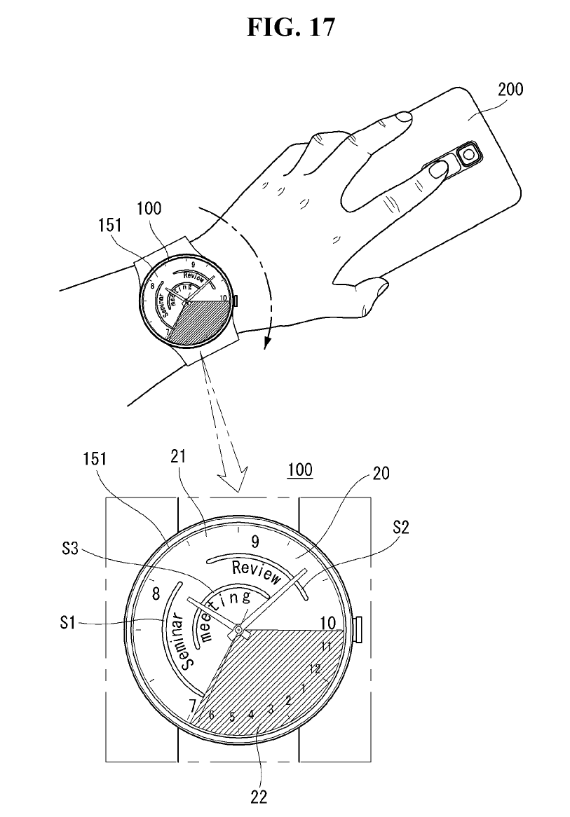

In this state, the user may make a first gesture to inward turn the wrist in order to check the mobile terminal 100 worn on the wrist, as shown in FIG. 17. This is only an example and the present invention is not limited thereto. In some embodiments, another gesture may be set as the first gesture.

When a motion of the mobile terminal 100 according to the first gesture is sensed by the sensing unit 140, the controller 180 may receive schedule information set in accordance with the selected date information through the wireless communication unit 110.

Referring back to FIG. 15, the controller 180 may display a first screen on which the schedule information set in accordance with the date information is displayed according to a time sequence on the touch screen at step S210.

Referring to FIG. 17, the controller 180 may display a first screen 20 on which received schedule information S1, S2, and S3 is displayed according to a time sequence on the touch screen 151. The first screen 20 may include an analog watch screen indicative of the current time as a background. In FIG. 17, the three pieces of schedule information S1, S2, and S3 have been illustrated, but the present invention is not limited thereto. The number of pieces of schedule information displayed on the first screen 20 may be set based on the number of pieces of schedule information set by a user.

For example, the controller 180 may map the schedule information S1, S2, and S3 to respective analog watch screens included in the first screen 20 so that they correspond to a set time sequence, and may display them. That is, if the schedule information S1 has been set to be from 7:00 to 8:15, it may be displayed with respect to a corresponding time interval, as shown in FIG. 17.

For example, the schedule information S1, S2, and S3 may be displayed by the forenoon and the afternoon. For example, the schedule information S1 and S2 set in the forenoon may be displayed in an outer line, and the schedule information S3 set in the afternoon may be displayed in an inner line. This is only an example and the present invention is not limited thereto. If schedule information can be classified by the forenoon and the afternoon, any visual effect including a symbol, text, etc. may also be applied to the schedule information.

For example, the controller 180 may divide the first screen 20 into a region 21 having an extended time interval and a region 22 having a reduced time interval, and may display the regions as shown in FIG. 17. The controller 180 may display a region, including a set schedule, as the extended region 21. A plurality of the extended regions 21 may be displayed depending on the number and time of set schedules. Furthermore, the ratio in which a time interval is extended in the extended region 21 may be controlled depending on the number of extended regions.

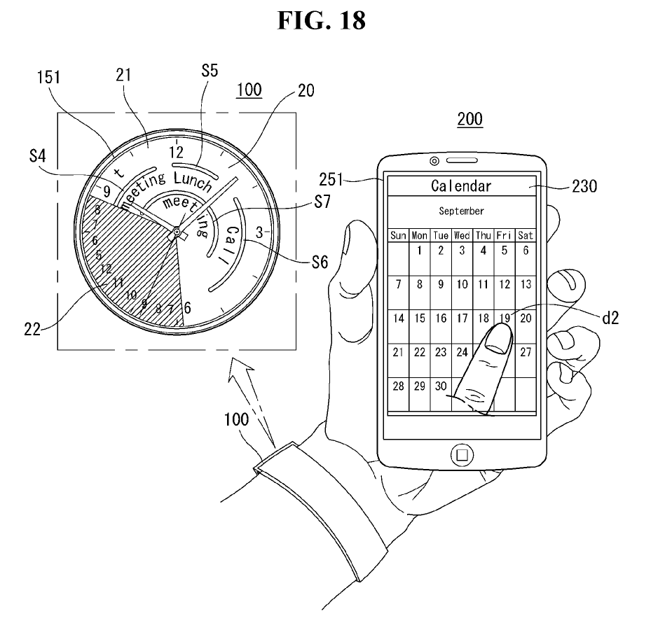

FIG. 18 shows a diagram viewed in the direction opposite the direction of FIG. 17. This state means that the user watches a screen of the mobile terminal 100. For example, the user may select another piece of date information d2 (e.g., “September 19”) in the execution screen 230. For example, the user may select the date information d2 by moving only the external device 200 by the other hand in the state in which the user watches the mobile terminal 100. Alternatively, if the external device 200 is a transparent display device, the user may check and select the date information d2 through the back side.

In this case, the controller 180 may receive schedule information corresponding to newly selected date information d2 from the external device 200. The controller 180 may display schedule information S4, s5, s6, and s7, corresponding to the date information d2, on the first screen 20.

For example, the user may select the schedule information S4 that belongs to the schedule information S4, s5, s6, and s7 displayed on the first screen 20 and that is to be checked as a second item. For example, when a predetermined touch input (e.g., a force touch input applied with a first strength) is inputted to the schedule information S4, the controller 180 may display information about the selected schedule information S4 on the touch screen 151.

For another example, when another predetermined touch input (e.g., a force touch input applied with a second strength) is inputted to the schedule information S4, the controller 180 may display a mark indicating that the selected schedule information S4 has been selected in the schedule information S4.

Referring back to FIG. 15, when a motion of the mobile terminal according to a second gesture of the user is sensed, the controller 180 may transmit a control signal that enables a screen for editing a schedule selected in the first screen to be displayed to the external device at step S220.

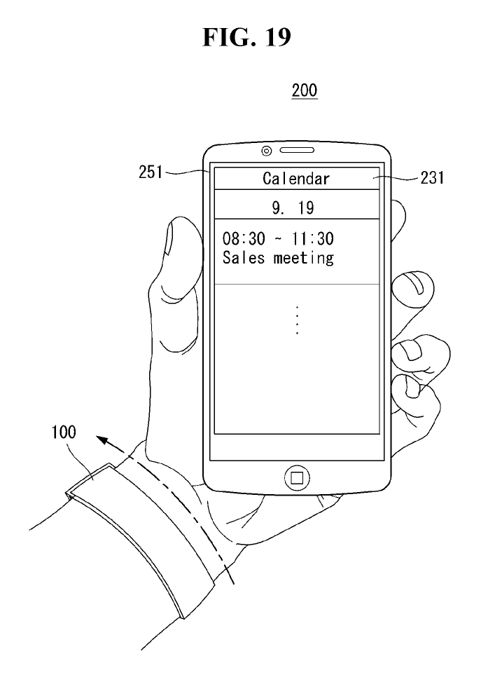

As shown in FIG. 19, the user may make the second gesture to outward turn the wrist on which the mobile terminal 100 has been worn. This is only an example and the present invention is not limited thereto. In some embodiments, another gesture may be set as the second gesture.

When a motion of the mobile terminal 100 according to the second gesture is sensed, the controller 180 may transmit a control signal that enables a screen for editing the selected schedule S4 to be displayed to the external device 200. For example, the screen for editing the schedule S4 may be a schedule edit screen of the execution screens of the calendar application.

Referring to FIG. 19, the controller of the external device 200 may display the schedule edit screen 231 of the calendar application on the display unit 251 in response to the control signal. The user may check or edit the schedule in the schedule edit screen 231.

Accordingly, a user can check schedule information conveniently because the schedule information about a date selected in a calendar application is displayed through interoperability between the external device and the watch type mobile terminal in response to a user gesture.

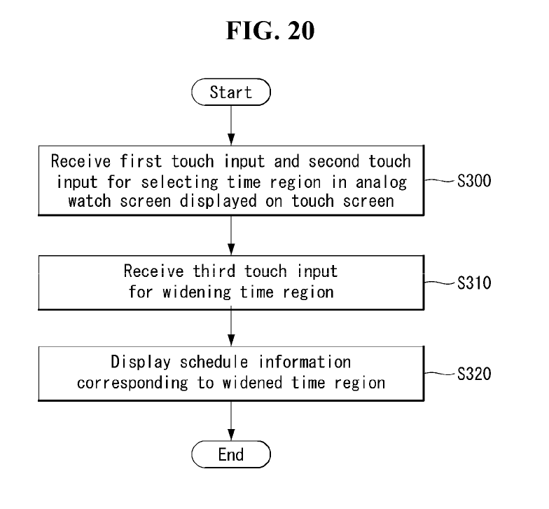

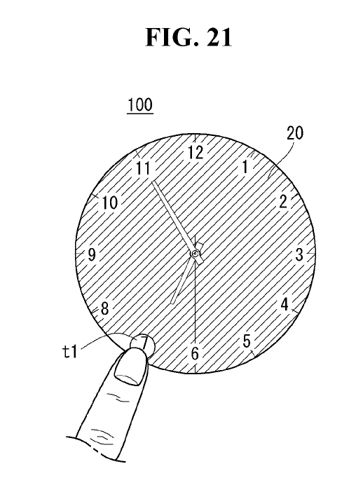

FIG. 20 is a flowchart illustrating a method for displaying detailed information related to information displayed on the touch screen in accordance with an embodiment of the present invention. FIGS. 21 to 23 are diagrams illustrating an example in which detailed information related to information displayed on the touch screen is displayed in response to a touch input in accordance with an embodiment of the present invention.

A method for controlling a mobile terminal according to an embodiment of the present invention may be implemented in the mobile terminal 100 described with reference to FIG. 1. A method for controlling a mobile terminal according to an embodiment of the present invention and an operation of the mobile terminal 100 for implementing the method are described in detail below with reference to required drawings.

Referring to FIG. 20, the controller 180 may receive a first touch input and a second touch input for selecting a time region in an analog watch screen displayed on the touch screen at step S300.

For example, the controller 180 may change the display of information related to the first item in response to a touch input received in the first screen. FIG. 21 shows an example in which an analog watch screen has been displayed on the first screen 20. It is assumed that in the first screen 20, the first gesture was sensed in the state in which the date information has been selected and thus the schedule information corresponding to the selected date information has been received, as described above with reference to FIGS. 16 and 17.

This is only an example and the present invention is not limited thereto. If information related to a first item selected in a screen of an application being executed in the external device 200 has been received, the following description may be applied substantially in the same manner.

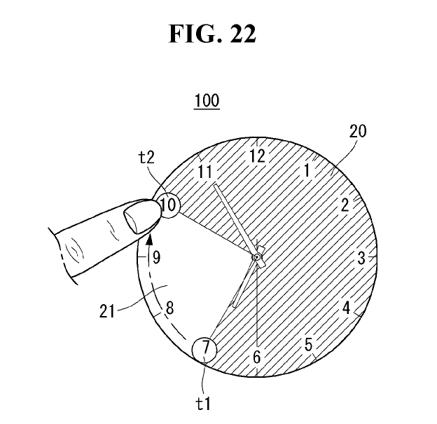

The user may select a time region in which the received schedule information is to be checked. The user may apply a first touch input for selecting a first time t1, as shown in FIG. 21. The user may apply a second touch input for selecting a second time t2, as shown in FIG. 22. For example, the controller 180 may display the first time t1, the second time t2, and a region 21 of a fan shape that connects the center of the watch in different colors so that they are distinguished from other regions.

Referring back to FIG. 20, the controller 180 may receive a third touch input for widening the time region at step S310.

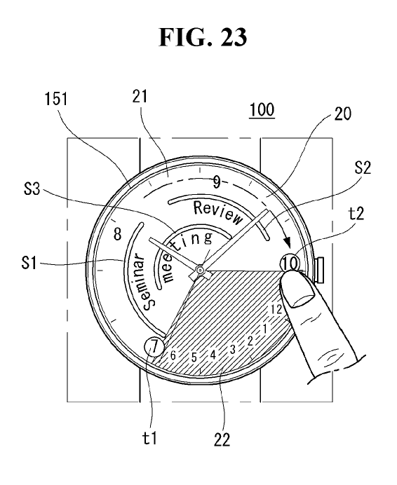

For example, as shown in FIG. 23, the third touch input may be a drag touch input that is applied clockwise in the state in which the second time t2 has been touched. This is only an example and the present invention is not limited thereto. In some embodiments, the third touch input may be differently set like an input for touching another point of the first screen 20.

Referring back to FIG. 20, the controller 180 may display schedule information corresponding to the widened time region at step S320.

The controller 180 may extend the time interval of the region 21 in response to the drag touch input, as shown in FIG. 23. The controller 180 may display set schedules S1, S2, and S3 between the first time t1 and the second time t1 in the region 21 having the extended time interval. Accordingly, the time interval of another region 22 distinguished from the region 21 may be reduced. The display of the schedules S1, S2, and S3 has been described with reference to FIG. 17, and a detailed description thereof is omitted.

Accordingly, a user can check displayed information more intuitively because information displayed on a screen of the watch type mobile terminal is differently displayed in response to a touch input.

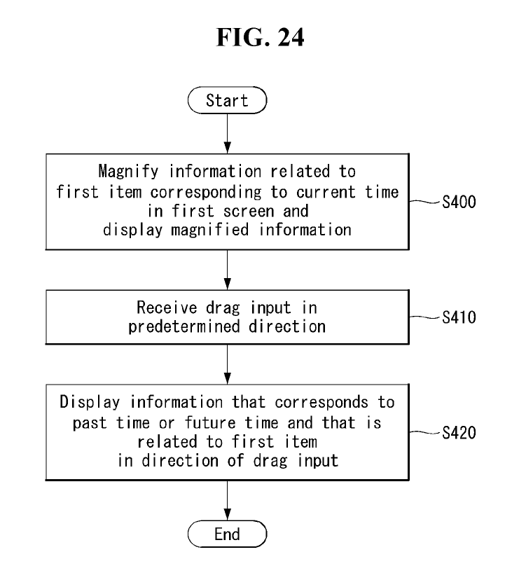

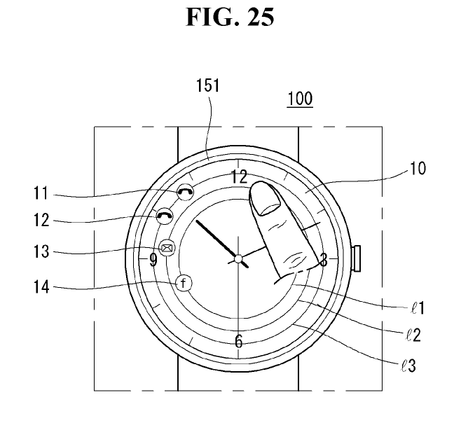

FIG. 24 is a flowchart illustrating a method for magnifying information displayed on the touch screen and displaying the magnified information in accordance with an embodiment of the present invention. FIGS. 25 to 27 are diagrams illustrating an example in which information displayed on the touch screen is magnified and displayed and information about another part is checked in accordance with an embodiment of the present invention.

A method for controlling a mobile terminal according to an embodiment of the present invention may be implemented in the mobile terminal 100 described with reference to FIG. 1. A method for controlling a mobile terminal according to an embodiment of the present invention and an operation of the mobile terminal 100 for implementing the method are described in detail below with reference to required drawings.

Referring to FIG. 24, the controller 180 may magnify information related to a first item corresponding to the current time in a first screen, and may display the magnified information at step S400.

For example, the controller 180 may change the display of information related to the first item in response to a touch input received in the first screen. FIG. 25 shows communication histories corresponding to contact information selected in the first screen 10, as described above with reference to FIGS. 6 and 7. Furthermore, it is assumed that schedule information has been set.

This is only an example and the present invention is not limited thereto. If information related to a first item selected in a screen of an application being executed in the external device 200 has been received and displayed according to a time sequence, the following description may be applied substantially in the same manner.

Referring to FIG. 25, a user may apply a predetermined touch input in order to magnify and display information related to a first item corresponding to the current time. For example, the predetermined touch input may be an input that touches the first screen 10 for a specific time or more. This is only an example and the present invention is not limited thereto. The predetermined touch input may be set as various types of touches, such as a short touch, a long touch, a multi-touch, a drag touch, a flick touch, a pinch-in touch, a pinch-out touch, a swipe touch, and a hovering touch, or a combination of them.

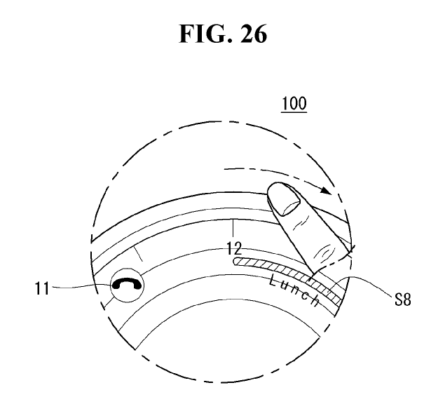

When the predetermined touch input is applied, the controller 180 may magnify a region that belongs to the first screen 10 and that corresponds to the current time, and may display the magnified region as shown in FIG. 26. For example, the controller 180 may display schedule information S8, set in the current time, in the magnified region.

Referring back to FIG. 24, when a drag input in a predetermined direction is received at step S410, the controller 180 may display information that corresponds to the past time or future time and that is related to the first item in the direction of the drag input at step S420.

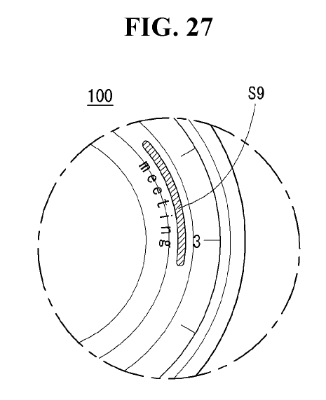

A user may apply a drag input to the first screen 10 clockwise as shown in FIG. 26. The controller 180 may display schedule information S9, corresponding to the future time, in the magnified region in response to the drag input as shown in FIG. 27. Likewise, a user may apply a drag input to the first screen 10 counterclockwise. The controller 180 may display schedule information, corresponding to the past time, in the magnified region in response to the drag input.

Accordingly, a user can check displayed information more intuitively because information displayed on a screen of the watch type mobile terminal is differently displayed in response to a touch input.

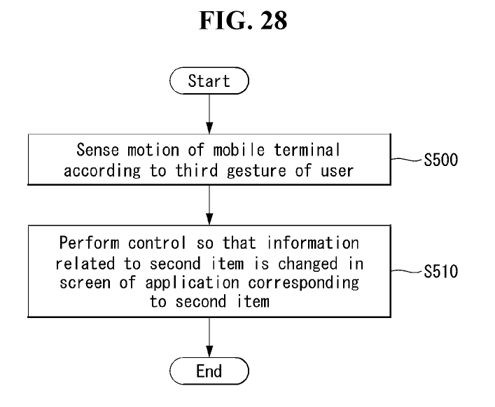

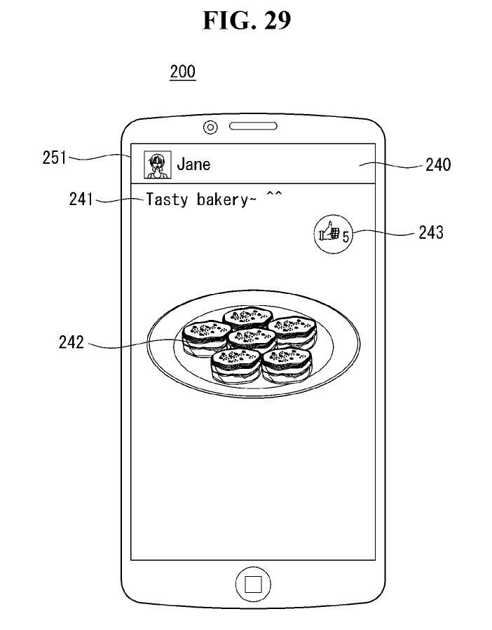

FIG. 28 is a flowchart illustrating a method for changing information about an application in response to a user gesture in accordance with an embodiment of the present invention. FIGS. 29 to 31 are diagrams illustrating an example in which information about an application is changed in response to a user gesture in accordance with an embodiment of the present invention.

A method for controlling a mobile terminal according to an embodiment of the present invention may be implemented in the mobile terminal 100 described with reference to FIG. 1. A method for controlling a mobile terminal according to an embodiment of the present invention and an operation of the mobile terminal 100 for implementing the method are described in detail below with reference to required drawings.

Referring to FIG. 28, the controller 180 may sense a motion of the mobile terminal according to a third gesture of a user at step S500.

As shown in FIG. 29, the execution screen 240 of an SNS application has been displayed on the display unit 251 of the external device 200. It is assumed that in the execution screen 240, the first gesture of the user was sensed and thus the SNS log of a counterpart corresponding to specific contact information, that is, the second item, has been displayed, as described above with reference to FIGS. 8 and 9. The execution screen 240 may include a comment 241 and image 242 uploaded by the counterpart and a good will expression 243 of other persons with respect to the comment 241 and the image 242, that is, information related to the second item.

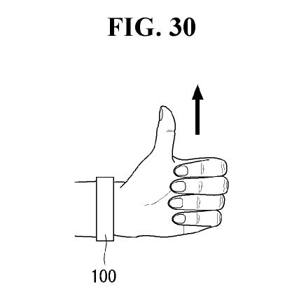

If the user wants to express a good will for the comment 241 and the image 242, he or she may make a predetermined third gesture. For example, the third gesture may be an action of lifting the thumb of a hand on which the mobile terminal 100 has been worn as shown in FIG. 30. This is only an example and the present invention is not limited thereto. In some embodiments, the third gesture may be set as various actions.

The sensing unit 140 may sense a motion of the mobile terminal 100 according to the third gesture using various sensors. The sensing of the gesture has been described above, and a detailed description thereof is omitted.

Referring back to FIG. 28, the controller 180 may perform control so that information related to a second item is changed in a screen of an application corresponding to the second item at step S510.

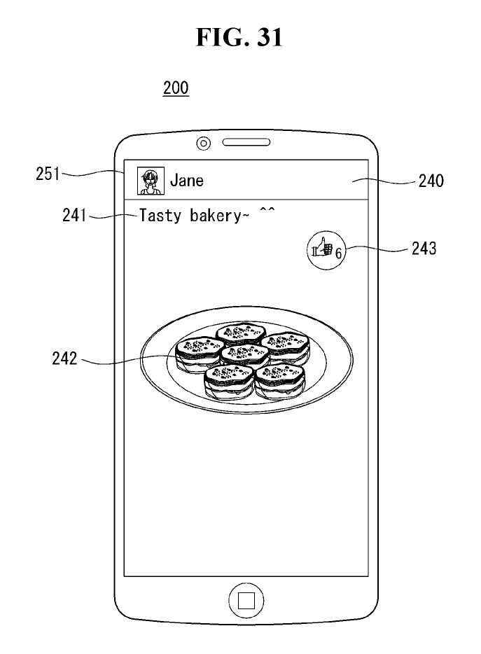

When the third gesture is sensed, the controller 180 may perform an operation for changing information related to a second item. For example, if the information related to the second item is the good will expression 243, the controller 180 may transmit a signal that selects a good will expression to an SNS server. Referring to FIG. 31, the number of good will expressions 243 may be changed from “5” to “6” in response to the transmitted signal.

Accordingly, a user can apply a specific input using a simple gesture by changing information in an external device through a user gesture in the state in which the user has worn the watch type mobile terminal.

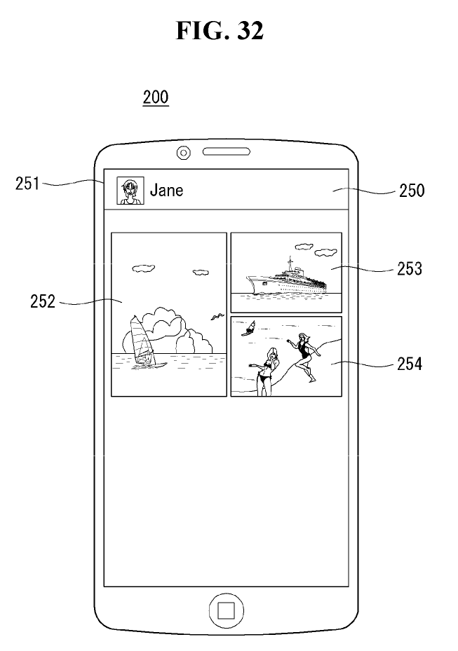

FIGS. 32 to 34 are diagrams illustrating an example in which an image included in an application is displayed on the watch type mobile terminal while operating in conjunction with an external device in accordance with an embodiment of the present invention.

As shown in FIG. 32, the execution screen 250 of an SNS application has been displayed on the display unit 251 of the external device 200. It is assumed that in the execution screen 250, the first gesture of the user was sensed and thus the SNS log of a counterpart corresponding specific contact information, that is, the second item, has been displayed as described above with reference to FIGS. 8 and 9. The execution screen 250 includes images 252, 253, and 254 uploaded by the counterpart.

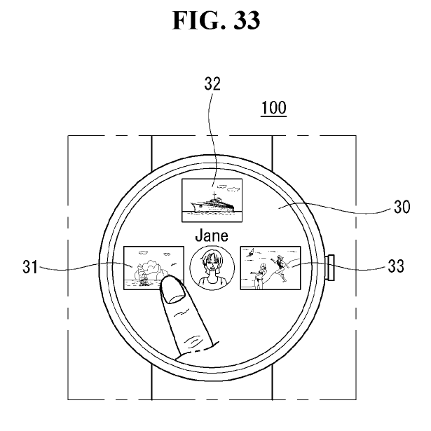

For example, when a user makes a gesture to check the mobile terminal 100, the controller 180 may display thumbnail images 31, 32, and 33, corresponding to the respective images 252, 253, and 254, on the touch screen 151 as shown in FIG. 33. For example, when a rightward flick touch input is applied to the touch screen 151, the controller 180 may display thumbnail images of images uploaded prior to the images 252, 253, and 254. When a leftward flick touch input is applied to the touch screen 151, the controller 180 may display thumbnail images of images uploaded after the images 252, 253, and 254.

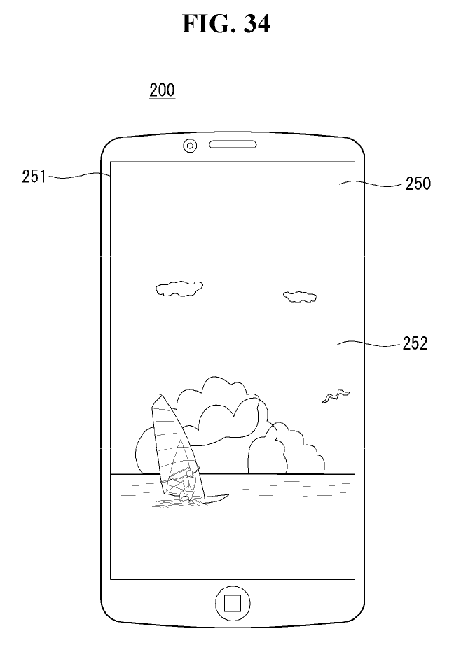

When the user selects the thumbnail image 31 to be checked, the controller 180 may transmit a control signal that enables the image 252 corresponding to the selected thumbnail image 31 to be displayed to the external device 200. The controller of the external device 200 may display the image 252 on the display unit 251 in response to the control signal, as shown in FIG. 34.

Accordingly, an image selected in the mobile terminal 100 can be easily checked on a large screen of the external device 200.

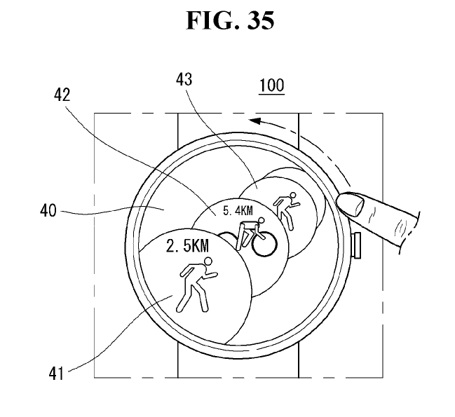

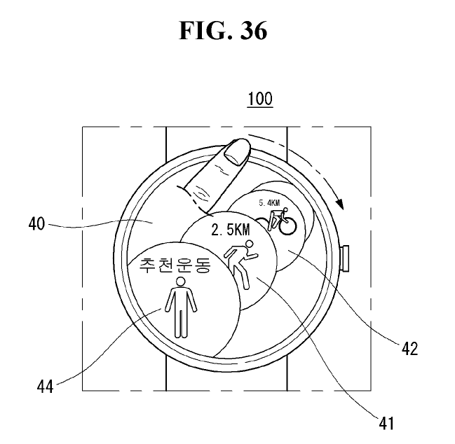

FIGS. 35 and 36 are diagrams illustrating an example in which information displayed on the touch screen is changed based on the direction of a touch input in accordance with an embodiment of the present invention.

For example, the controller may receive a touch input in a predetermined direction in the first screen, and may change information related to the first item displayed on the first screen according to a time sequence based on the direction of the received touch input.

As shown in FIG. 35, a screen 40 on which exercise information 41, 42, and 43 performed in connection with date information, that is, the first item, has been displayed on the touch screen 151 of the mobile terminal 100. For example, the exercise information 41, 42, and 43 may be partially overlapped and displayed according to a time sequence. For example, the exercise information 41 displayed at the top may be an exercise that has been most recently performed in the date information.

For example, a user may apply a drag input counterclockwise as shown in FIG. 35. At this time, the controller 180 may display the exercise information 41, 42, and 43 as if the exercise information moves sequentially forward. When the exercise information 41 displayed at the top moves by a specific distance or higher and disappears from the touch screen 151, the next exercise information 42 may be displayed at the top.

For example, a user may apply a drag input clockwise as shown in FIG. 36. At this time, the controller 180 may display the exercise information 41, 42, and 43 as if the exercise information sequentially moves backward. When the exercise information 41 displayed at the top moves by a specific distance or higher, the next exercise information 44 may be displayed at the top.

An example in which exercise information has been displayed has been described as a premise, but the present invention is not limited thereto. Any information may be changed based on the direction of a drag input and displayed if information related to the first item may have only to be displayed according to a time sequence.

Accordingly, a user can check the past or future information conveniently by changing displayed information according to a time sequence based on the direction of a touch input for the watch type mobile terminal.

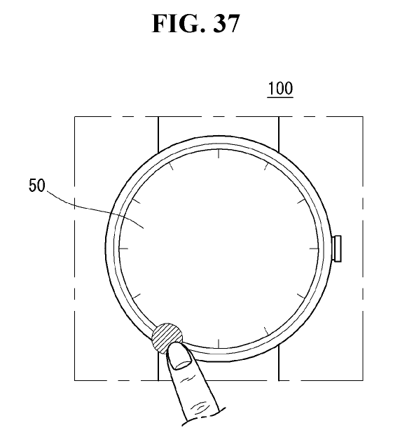

FIGS. 37 to 39 are diagrams illustrating an example in which the location of an external device connected to the watch type mobile terminal for communication is displayed in accordance with an embodiment of the present invention.

As shown in FIG. 37, a first screen 50 has been displayed on the touch screen 151 of the mobile terminal 100. It is assumed that in the first screen 50, the first gesture was sensed in the state in which date information has been selected and thus schedule information corresponding to the selected date information has been received as described above with reference to FIGS. 16 and 17.

A user may select time at which the received schedule information is to be checked. For example, a user may apply a touch input to the region in order to check a schedule set around 7:00, as shown in FIG. 37.

For example, the controller 180 may check schedule information set at a time corresponding to the region to which the touch input has been applied. For example, it is assumed that the checked schedule is an appointment to gather at a specific location “m.”

The controller 180 may check persons who gather according to the appointment in the schedule information. The controller 180 may read contact information, corresponding to persons included in the schedule information, from the memory 170. The controller 180 may transmit a signal that requests information about the locations of the persons included in the schedule information to electronic devices corresponding to the contact information.

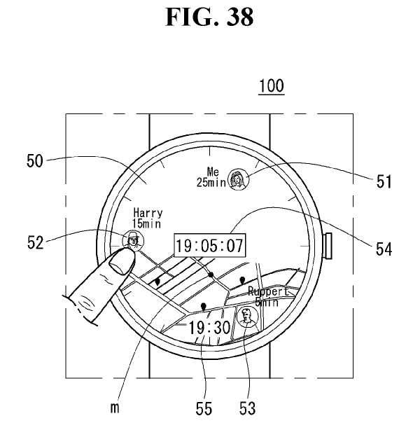

The controller 180 may check information about the specific location “m” in the schedule information. The controller 180 may obtain a two-dimensional or three-dimensional map for the specific location “m” from the memory 170 or over an external network. The controller 180 may display the obtained map on the first screen 50 as shown in FIG. 38.

The controller 180 may display the specific location “m” in the map displayed on the first screen 50. Furthermore, the controller 180 may display information about the locations of the persons, received from the electronic devices corresponding to the contact information and included in the schedule information, in the form of images 51, 52, and 53. The controller 180 may display current time information 54 and appointment time information 55 on the first screen 50.

For example, the controller 180 may display information about the IDs of the persons included in the schedule information along with the information about the location of the persons included in the schedule information. Furthermore, the controller 180 may display information about an arrival time for the specific location “m” using the moving speed of the persons and information about the distance to the specific location “m”, which are included in the schedule information.

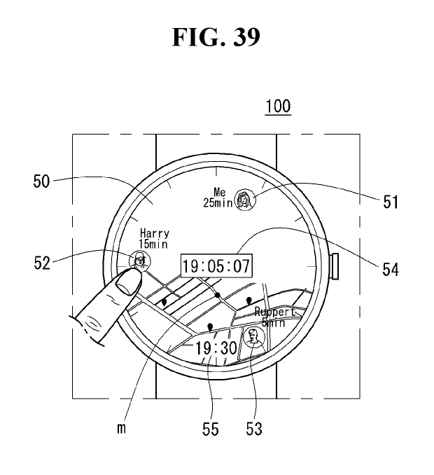

For example, the user may select the image 52 corresponding to a person who belongs to the persons included in the schedule information and whose location is to be checked. The controller 180 may display the map displayed on the first screen 50 again based on the location of the selected image 52, as shown in FIG. 39. For example, the controller 180 may display a process of changing the map on the first screen 50 so that the location of the selected image 52 is placed at the center.

Accordingly, information about a specific schedule can be checked conveniently through only a simple touch input.

As described above, the watch type mobile terminal 100 has been illustrated as operating in conjunction with the external device 200 based on the watch type mobile terminal 100. The aforementioned contents may be applied to an example in which the watch type mobile terminal operates as an external device and an external device operates as the mobile terminal substantially in the same manner.

In this case, the mobile terminal may be connected to a watch type external device for communication through the wireless communication unit. When a motion of the external device according to a first gesture of a user is sensed, the controller of the mobile terminal may transmit information related to a first item, selected in a screen of an application, to the external device.

Furthermore, when a motion of the external device according to the second gesture of the user is sensed, the controller of the mobile terminal may receive a control signal that enables information related to a second item selected in a screen on which the information related to the first item is displayed according to a time sequence to be displayed. The controller 180 may display the information related to the second item on the touch screen in response to the control signal.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

What is claimed is:

1. A watch type mobile terminal, comprising:
a wireless communication unit configured to be connected to an external device for communication;
a sensing unit configured to sense a motion of the mobile terminal;
a touch screen; and
a controller configured to receive information related to a first item selected in a screen of an application being executed in the external device when a motion of the mobile terminal according to a first gesture of a user who has worn the mobile terminal is sensed, to display a first screen on which the information related to the first item is displayed according to a time sequence on the touch screen, and to transmit a control signal which enables a screen of an application corresponding to a second item selected in the first screen to be displayed to the external device when a motion of the mobile terminal according to a second gesture of the user is sensed.

2. The mobile terminal of claim 1, wherein:
the first item comprises contact information included in a contact list application, and
the controller is configured to display communication histories between the user and a counterpart corresponding to the contact information on the first screen according to a time sequence.

3. The mobile terminal of claim 2, wherein:
the communication history comprises at least one of a call log, a message, and an SNS log between the counterpart and the user, and
the controller is configured to transmit a control signal which enables an execution screen of an application corresponding to a selected communication history of the communication histories displayed on the first screen to be displayed when the motion of the mobile terminal according to the second gesture of the user is sensed.

4. The mobile terminal of claim 1, wherein:
the first item comprises date information included in a calendar application, and
the controller is configured to display schedule information set in accordance with the date information on the first screen according to a time sequence.

5. The mobile terminal of claim 4, wherein the controller is configured to transmit a control signal which enables a screen for editing a schedule selected in the first screen to be displayed to the external device when the motion of the mobile terminal according to the second gesture of the user is sensed.

6. The mobile terminal of claim 1, wherein the controller is configured to:
display an analog watch screen in a background of the first item, and
display the information related to the first item by mapping the information to the analog watch screen so that the information corresponds to a generated time sequence.

7. The mobile terminal of claim 1, wherein the controller is configured to change the display of the information related to the first item in response to a touch input received in the first screen.

8. The mobile terminal of claim 1, wherein the controller is configured to change information related to the second item in a screen of an application corresponding to the second item based on a sensed motion when the motion of the mobile terminal according to a third gesture of the user is sensed.

9. The mobile terminal of claim 1, wherein the controller is configured to:
receive a touch input in a predetermined direction in the first screen, and
change the information related to the first item displayed on the first screen according to a time sequence based on the direction of the received touch input.

10. A mobile terminal, comprising:
a wireless communication unit configured to be connected to a watch type external device for communication;
a touch screen; and
a controller configured to execute an application, to transmit information related to a first item selected in a screen of the application to the external device when a motion of the external device according to a first gesture of a user is sensed, to receive a control signal which enables information related to a second item selected in a screen on which the information related to the first item has been displayed according to a time sequence to be displayed when a motion of the external device according to a second gesture of the user is sensed, and to display the information related to the second item on the touch screen.
